(19) United States
(12) Patent Application Publication
(10) Pub. No.: US 2008/0307937 A1
(43) Pub. Date: Dec. 18, 2008

(54) DEVICE AND METHOD FOR PRODUCING FILM PACKAGES

(76) Inventors: Walter Neal Simmons, Durham, NC (US); Walter John Simmons, Martinsburg, WV (US)

Correspondence Address: STEPTOE & JOHNSON LLP, 1330 CONNECTICUT AVENUE, N.W., WASHINGTON, DC, 20036, US

(21) Appl. No.: 12/139,989

(22) Filed: Jun. 16, 2008

Related U.S. Application Data
(60) Provisional application No. 60/944,486, filed on Jun. 15, 2007.

(51) Int. Cl. B26D 1/00

(52) U.S. Cl. 83/36; 83/697

(57) ABSTRACT

A method of producing packages of flowable materials may include: passing a plurality of coupled packages through a cutter having a blade with dual cutting edges; and severing adjacent packages in a region proximate ends thereof by a single stroke of the blade so that only one edge of the blade contacts the region. In addition, a cutter may include a housing that is substantially symmetrical about a longitudinal axis thereof, the housing defining an opening having opposing first and second sections each with an arcuate region proximate a tapered region, the opening further comprising a central region disposed between the first and second sections. The cutter may include a blade with dual cutting edges, the blade disposed proximate the central region of the housing.

### CROSS-REFERENCE TO RELATED APPLICATION

The benefits of Provisional Application No. 60/944,486 filed Jun. 15, 2007 are claimed under 35 U.S.C. § 119(e), and the entire contents of this application are expressly incorporated herein by reference thereto.

### FIELD OF THE INVENTION

The invention relates to a device and method for producing film packages. More particularly, the invention relates to a device and method for severing sealed tubular packages formed from a web of film.

### BACKGROUND OF THE INVENTION

The primary roof support systems used in coal mines include headed rebar bolts typically 4 feet to 6 feet in length, ¾ inch and ⅝ inch in diameter, and used in conjunction with resin grouting in 1 inch diameter holes.

Typically, grouting is accomplished using multi-compartment resin cartridges. A variety of such cartridges are known disclosed in U.S. Pat. No. 3,861,522 to Llewellyn, U.S. Pat. No. 4,239,105 to Gilbert, and U.S. Patent Application Publication No. US 2007/0017832 A1 to Simmons et al. Multi-compartment cartridges are designed to keep the polymerizable resin and catalyst separate from each other until the cartridge, when inserted in a borehole, is intentionally ruptured by a mine roof bolt that also is inserted in the borehole. When the resin and catalyst are mixed (by virtue of rupture as well as spinning of the bolt in the borehole) and subsequently harden, the bolt is held in place.

In some prior art devices and methods for forming partitioned film packages such as multi-component resin cartridges, a series of cartridges are formed and then cut at a clipping head associated with the package-forming apparatus or in a separate operation from the cartridge forming operation, i.e., off-line using a cutter separate from the clipping head. In particular, the cartridges are separated from one another proximate their clipped ends, i.e., proximate the regions of the opposite ends of the cartridges which are each clipped so as to retain the resin and catalyst in the package. Thus, before being separated, adjacent cartridges have two clips adjacent each other with some cartridge packaging disposed therebetween. A cut is made between the adjacent clips to separate the cartridges. Problems associated such prior art devices and methods include clogging of resin/catalyst at the clipping head and/or cutting blade. For example, the clipping is not always tight enough or there is leaking of the resin/catalyst where the cutting occurs, thus causing a build-up of sticky and/or hardened resin/catalyst at the clipping head and/or cutting blade. Because of this build-up, prior art cutting blades for example may only be used in a manufacturing operation for four hours, and then are replaced and discarded because of the degradation in performance. In addition, such prior art devices and methods also only make single passes of a cutting blade, i.e., in the form of a guillotine which descends between adjacent clips to cut the material therebetween and separate adjacent cartridges, and then is lifted to again drop make another cut. Such one-way operation is inefficient inasmuch as it is slow.

Thus, for example, there is a need for improved devices and methods for forming partitioned film packages.

### SUMMARY OF THE INVENTION

In one exemplary embodiment, a method of producing packages of flowable materials includes: passing a plurality of coupled packages through a cutter having a blade with dual cutting edges; and severing adjacent packages in a region proximate ends thereof by a single stroke of the blade so that only one edge of the blade contacts the region. A first pair of coupled packages may be severed from each other on a first stroke by a first edge of the blade, and a second pair of coupled packages may be severed from each other on a second stroke by a second edge of the blade. The adjacent packages may have adjacent clips proximate respective ends thereof and the adjacent packages may be severed between the adjacent clips. The method may further include: centering adjacent ends of adjacent packages in the cutter prior to severing the adjacent packages. In some embodiments, the adjacent ends may be centered by guiding the adjacent ends along a tapered inner wall of the cutter toward a central region where the blade is disposed. Also, adjacent packages may be severed while disposing the blade transverse to a central axis of the cutter. For example, the flowable materials may be catalyst and resin. In some embodiments, the cutter may be magnetically coupled to a fixture.

In another exemplary embodiment, a method of producing multi-compartment cartridges each for storing catalyst and resin for use with a mine roof support, includes: guiding a plurality of coupled cartridges through a cutter having a blade with dual cutting edges while centering adjacent cartridges with respect to the blade; severing a first pair of adjacent cartridges on a first stroke by a first edge of the blade; severing a second pair of adjacent cartridges on a second stroke opposite in direction from the first stroke and by a second edge of the blade. In some embodiments, each pair of adjacent cartridges may have adjacent clips proximate respective ends thereof and the adjacent cartridges may be severed between the adjacent clips. In addition, during the centering, adjacent cartridges may be guided along opposing tapered inner walls of the cutter toward a central region where the blade is disposed. Moreover, in some embodiments, adjacent cartridges may be severed while disposing the blade transverse to a central axis of the cutter. In some embodiments, the cutter may be magnetically coupled to a fixture.

In yet another exemplary embodiment, a cutter may include: a housing that is substantially symmetrical about a longitudinal axis thereof, the housing defining an opening including opposing first and second sections each with an arcuate region proximate a tapered region, the opening further including a central region disposed between the first and second sections; and a blade with dual cutting edges, the blade disposed proximate the central region of the housing. In some embodiments, the cutting edges may be disposed transverse to the longitudinal axis of the housing, and the cutting edges may be parallel to one another. In some embodiments, the housing and blade may be demountably coupled to each other, while in other embodiments, the housing may be formed of unitary construction to retain the blade. Also, in some embodiments, the housing may be formed of front and back portions demountably coupled to each other, and the blade may be retained between the front and back portions in a recess. For example, the housing may be formed of aluminum or polymer. In addition, in some embodiments, the cutter further may include a region to which a magnet may be attracted to magnetically couple the cutter to a fixture.

### BRIEF DESCRIPTION OF THE DRAWINGS

Preferred features of embodiments are disclosed in the accompanying drawings, wherein:

FIG. 1 is a perspective view of an embodiment of a packaging system advancing packaging in direction D and severing a tube as shown;

FIG. 2 is a perspective view of the severing device of FIG. 1;

FIG. 3 is another perspective view of the severing device of FIG. 2;

FIG. 4 is a top view of the severing device of FIG. 2; and

FIG. 5 is a side view of the severing device of FIG. 2.

### DETAILED DESCRIPTION OF THE PREFERRED EMBODIMENTS

While an embodiment is described herein with reference to producing two-component cartridges containing resin and a catalyst component for effecting polymerization of the resin upon rupture of the cartridge and mixing of the components, particularly for use in anchoring mine roof bolts, this use is exemplary only and is not meant to be limiting. The resin cartridges for example may be used to anchor other structural components. Additionally, the two-component cartridge may be used for housing other components that may or may not be reactive with each other, and may or may not be used in the mining industry. One-component or more than two-component cartridges also are contemplated. A variety of applications are envisioned for the device and method for producing film packages disclosed herein, including applications in the foodstuffs industry such as packaged sausage, ground beef, or cookie dough.

For purposes of the description hereinafter, the terms “upper,” “lower,” “right,” “left,” “vertical,” “horizontal,” “top,” “bottom” and derivatives thereof shall relate to the embodiment as oriented in the figures. However, it is to be understood that the embodiment may assume various alternative orientations, unless expressly limited to the contrary. It is also to be understood that the specific devices and processes disclosed herein are simply exemplary embodiments of the invention. Hence, specific dimensions and other physical characteristics related to the embodiments disclosed herein are not to be considered as limiting.

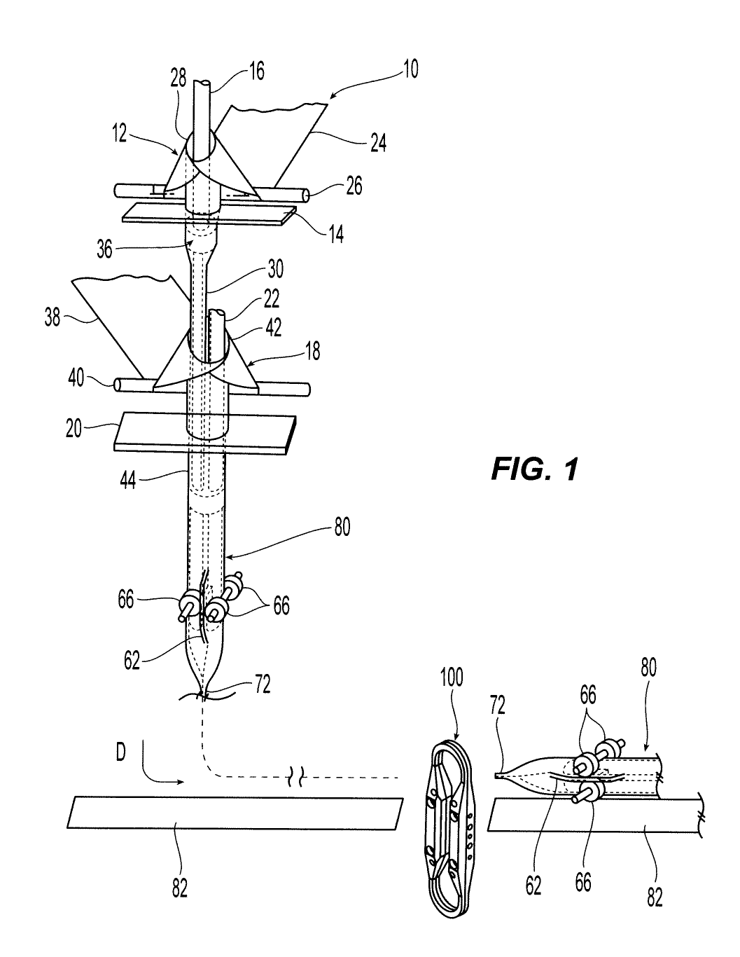

Turning to FIG. 1, an exemplary preferred embodiment of a packaging system for creating, advancing, and severing a tube is shown. The embodiment includes a device as disclosed for example in U.S. patent application Ser. No. 11/472,798 to Simmons et al., published as U.S. Patent Application Publication No. US 2007/0017832 A1 and entitled “Device for Forming Partitioned Film Packages,” the entirety of which is incorporated herein by reference thereto.

As shown in FIG. 1, apparatus 10 includes a first forming member 12 mounted on a support 14 and surrounding a first fill tube 16 and a second forming member 18 mounted on a support 20 and surrounding both of a second fill tube 22 and the first fill tube 16. A web 24 of a first pliable film moves continuously from a supply roll (not shown) and passes under at least one roller 26 and upwardly and over a curved edge 28 of the first forming member 12. The first forming member 12 is cut and shaped to cause the first web 24 to reverse its direction and to guide edges of the first web 24 downwardly into a convoluted tube forming relation around the first fill tube 16. As the first web 24 travels down the outside of the first fill tube 16, the edges of the web 24 overlap yielding an inner tube 30 with longitudinally extending overlapping portions. A heat seal is applied at 36 to seal the inner tube 30.

A second web 38 of pliable film extends over a roller 40 and upwardly and over an upper curved edge 42 of the second forming member 18 to surround both the inner tube 30 (and the first fill tube 16) and the second fill tube 22. The second fill tube 22 has a non-circular configuration and may generally have larger cross-sectional dimensions than the first fill tube 16. As the second web 38 travels past the second forming member 18 along the outside surfaces of the inner tube 30 and second fill tube 22, an outer tube 44 is formed from the second web 38 in an overlapping relationship with the second forming member 18.

At a lower end of the package forming apparatus 10, the first fill tube 16 and the second fill tube 22 have reduced cross-sectional dimensions. In one embodiment, fins 62 extend from opposing sides of the second fill tube 22. Opposing portions of the outer tube 44 are each engaged between a fin 62 and a pair of feed wheels 66. The feed wheels 66 engage the outer tube 44 for continuous advancement thereof towards a tube constricting and sealing unit (not shown).

As packages 80 are sealed at ends 72, through what is shown in the exemplary embodiment as a vertical tube filling operation in which materials such as catalyst and resin are delivered to and disposed in the packages by using the fill tubes as is known in the art, packages 80 may be reoriented to be disposed generally horizontally with respect to their central axes for transfer along a surface 82. Feed wheels or rollers 66 for example may be used to further move packages 80 across surface 82.

Even though packages 80 are sealed at ends 72, a plurality of packages 80 may be coupled to one another prior to reaching cutter 100 which may be used to sever packages 80 from one another. It should be noted, however, that a plurality of packages 80 may remain coupled to one another even after passing cutter 100 if so desired, with the cutting stroke of cutter 100 timed to sever adjacent packages 80 as desired. Once severed, packages 80 may be transferred along surface 82 for example to a receiving bin (not shown) for transfer, storage, and/or distribution.

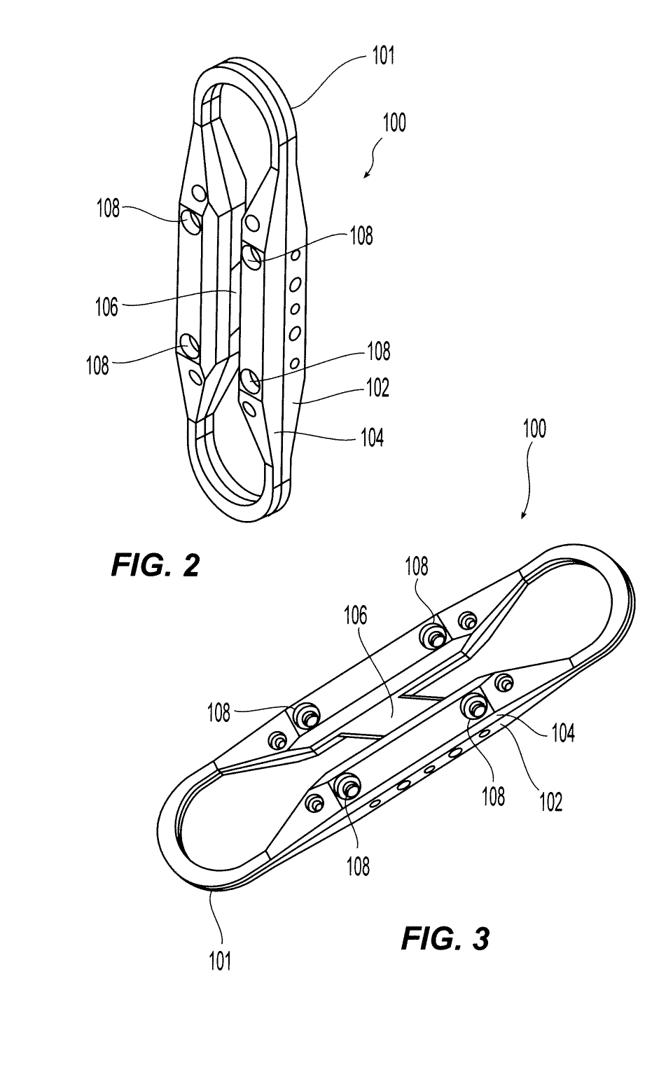

In an exemplary embodiment, shown for example in FIGS. 2-5, cutter 100 includes a housing 101 with a front portion 102 and a back portion 104 coupled to each other. A blade 106 (e.g., a razor blade) is secured between portions 102, 104, preferably in part fitting in recesses R formed therein. Portions 102, 104 for example may be coupled to one another with bolts received in aligned holes 108, which in one preferred exemplary embodiment are disposed in a central region of housing 101 proximate blade 106. Such a construction facilitates replacement of blade 106 when necessary for example due to dulling thereof or cleanliness issues.

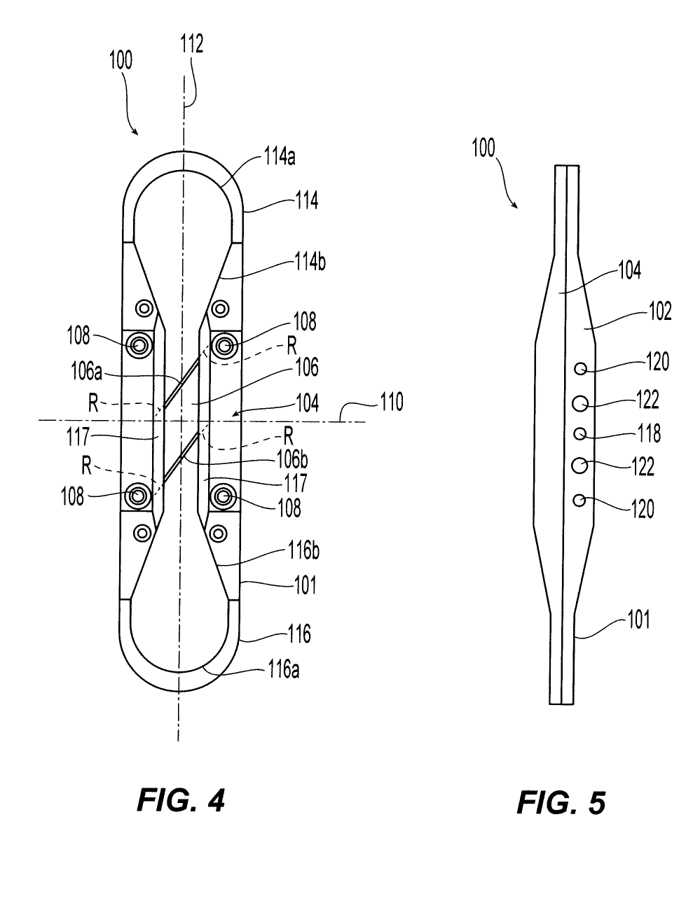

As shown for example in FIG. 4, housing 101 may be substantially symmetrical about an axis 110 perpendicular to longitudinal axis 112, and furthermore may be substantially symmetrical about longitudinal axis 112. Top portion 114 with respect to axis 110 may include an arcuate region 114a leading to a tapered region 114b which in turn leads to blade 106. Similarly, bottom portion 116 with respect to axis 110 may include an arcuate region 116a leading to a tapered region 116b which in turn leads to blade 106. Moreover, opposing tapered portions 117 may be provided proximate blade 106. Preferably, cutting edges 106a, 106b of blade 106 are each disposed transverse to axis 110, and also preferably are disposed substantially parallel to one another. The combination of arcuate and tapered open regions defined by housing 101 provides a self-centering feature, so that a package 80 disposed therein may be centered with respect to blade 106, thereby permitting adjacent packages to be severed by blade 106 proximate ends 72.

Blade 106 is provided with two, dual cutting edges 106a, 106b so that cutting action occurs both in a “downstroke” and in an “upstroke.” Thus, improved efficiency can be realized because cutter 100 need not be repositioned after each severing action provided by a cutting edge. In other words, in contrast to a prior art cutter with only a single cutting edge, dual cutting edges 106a, 106b of the embodiment shown herein permit cuts to be made from either side of blade 106.

In one embodiment, cutter 100 for example may be formed of aluminum for its lightweight characteristics, while the bolts coupling front and back portions 102, 104 may be formed of steel. A blade 106 formed of carbon steel also may be used. In another embodiment, a polymer housing 101 may be injection molded around a blade 106 to provide a unitary housing construction, obviating the need for separate portions 102, 104, with cutter 100 thus being disposable. In such an embodiment, blade 106 such as a carbon steel razor blade would not be replaced but instead an entire cutter 100 would be replaced when necessary for example due to dullness or cleanliness issues.

A handle 118 optionally may be couple to cutter 100 for example at coupling region 118.

For fixturing purposes, alignment pins (e.g., stainless steel, not shown) may be provided at regions 120, while steel bolts may be provided in regions 122 to permit a fixture with magnets to be attracted for coupling purposes to cutter 100.

The particular material selected for the webs 24 and 38 may be determined by the end-use of the package. In the context of a mine roof bolt resin package in which a polymerizable resin component and a catalyst are maintained in the package, polyethylene or polypropylene may be suitable for less aggressive environments where the risk of rupture or premature rupture is low. Stronger material is generally more costly but may be desirable in more aggressive environments such as in underground mining. In one embodiment, the outer tube 44 may be produced from a stronger film while the inner tube 30 may be produced from a weaker film. By using a weaker material for the inner tube 30, the force needed to puncture and shred the outer tube 44 will generally be sufficient to puncture and shred the inner tube 30. This ensures more effective mixing of reactive components. Accordingly, a resin cartridge may provide for enhanced puncturability and mixing of the contents within the two tubes. A difference in strength between the outer tube 44 and inner tube 30 can be achieved by using a thinner film for web 24 than for web 38. For example, when both of webs 24 and 38 are produced from polyethylene terephthalate, the web 38 may be 0.0005 to 0.003 inch (0.5 to 3 mil) thick and the web 24 may be 25% to 75% thinner than the web 38. Alternatively, a stronger material may be used for the web 30 than for the web 16, such as polyethylene terephthalate for web 38 and polyethylene or polypropylene for web 24. In such a case, the weaker web has a lower tensile modulus. When the package is produced using a material for the inner tube 30 having a lower modulus than the material of the outer tube 44, the inner tube 30 functions as a gasket to the outer tube 44 upon constriction and sealing of the package at the ends 72, which enhances the seal at the ends 66.

Furthermore, by using different materials for the inner tube 30 and outer tube 44, the tubes may have different vapor barrier properties. In a resin cartridge, to avoid loss of water from the catalyst compartment, the inner tube 30 may be produced from a material having low water permeability such as high-density polyethylene. Likewise, it can be beneficial for the outer tube 44 to exhibit low permeability to organic solvents present in a polymerizable resin composition. For example, polyester is one suitable material for the outer tube 44 to minimize permeation of organic materials therethrough. The structure of a resin cartridge may also be beneficial to retaining the integrity of the resin cartridge. Water loss from a resin cartridge can make the cartridge limp and increases the viscosity of the components mixed. Minimized water loss improves the shelf life of the resin cartridge. Escape of water in the catalyst component from the resin cartridge is minimized because the catalyst component is surrounded by the inner tube 30, the polymerizable resin and outer tube 44.

In one embodiment, the materials to be filled in the package are flowable materials such as fluids (typically liquids) and flowable solids such as powders or other particulate matter. For producing resin cartridges for use in anchoring mine roof bolts, one fill material may be a polymerizable resin such as a polyester resin and another fill material may be a polymerization catalyst. The sizes and relative dimensions of the inner tube 30 and outer tube 44 may vary depending on the end use of the package. Mine roof resin cartridges typically have an overall diameter of about 0.75 to 1.5 inch and a length of 12 to 60 inches.

While various descriptions of the present invention are described above, it should be understood that the various features can be used singly or in any combination thereof. Therefore, this invention is not to be limited to only the specifically preferred embodiments depicted herein.

Further, it should be understood that variations and modifications within the spirit and scope of the invention may occur to those skilled in the art to which the invention pertains. Accordingly, all expedient modifications readily attainable by one versed in the art from the disclosure set forth herein that are within the scope and spirit of the present invention are to be included as further embodiments of the present invention. The scope of the present invention is accordingly defined as set forth in the appended claims.

What is claimed is:

1. A method of producing packages of flowable materials comprising:
passing a plurality of coupled packages through a cutter having a blade with dual cutting edges; and
severing adjacent packages in a region proximate ends thereof by a single stroke of the blade so that only one edge of the blade contacts the region.

2. The method of claim 1, wherein a first pair of coupled packages are severed from each other on a first stroke by a first edge of the blade, and a second pair of coupled packages are severed from each other on a second stroke by a second edge of the blade.

3. The method of claim 1, wherein the adjacent packages comprise adjacent clips proximate respective ends thereof and the adjacent packages are severed between the adjacent clips.

4. The method of claim 1, further comprising:
centering adjacent ends of adjacent packages in the cutter prior to severing the adjacent packages.

5. The method of claim 4, wherein the adjacent ends are centered by guiding the adjacent ends along a tapered inner wall of the cutter toward a central region where the blade is disposed.

6. The method of claim 1, wherein adjacent packages are severed while disposing the blade transverse to a central axis of the cutter.

7. The method of claim 1, wherein the flowable materials are catalyst and resin.

8. The method of claim 1, wherein the cutter is magnetically coupled to a fixture.

9. A method of producing multi-compartment cartridges each for storing catalyst and resin for use with a mine roof support, the method comprising:
guiding a plurality of coupled cartridges through a cutter having a blade with dual cutting edges while centering adjacent cartridges with respect to the blade;
severing a first pair of adjacent cartridges on a first stroke by a first edge of the blade;
severing a second pair of adjacent cartridges on a second stroke opposite in direction from the first stroke and by a second edge of the blade.

10. The method of claim 9, wherein each pair of adjacent cartridges comprises adjacent clips proximate respective ends thereof and the adjacent cartridges are severed between the adjacent clips.

11. The method of claim 9, wherein during the centering, adjacent cartridges are guided along opposing tapered inner walls of the cutter toward a central region where the blade is disposed.

12. The method of claim 11, wherein adjacent cartridges are severed while disposing the blade transverse to a central axis of the cutter.

13. The method of claim 9, wherein the cutter is magnetically coupled to a fixture.

14. A cutter comprising:
a housing that is substantially symmetrical about a longitudinal axis thereof, the housing defining an opening comprising opposing first and second sections each with an arcuate region proximate a tapered region, the opening further comprising a central region disposed between the first and second sections;
a blade with dual cutting edges, the blade disposed proximate the central region of the housing.

15. The cutter of claim 14, wherein the cutting edges are disposed transverse to the longitudinal axis of the housing.

16. The cutter of claim 14, wherein the cutting edges are parallel to one another.

17. The cutter of claim 14, wherein the housing and blade are demountably coupled to each other.

18. The cutter of claim 14, wherein the housing is formed of unitary construction to retain the blade.

19. The cutter of claim 14, wherein the housing is formed of front and back portions demountably coupled to each other.

20. The cutter of claim 19, wherein the blade is retained between the front and back portions in a recess.

21. The cutter of claim 14, wherein the housing is formed of aluminum.

22. The cutter of claim 14, wherein the housing is formed of polymer.

23. The cutter of claim 14, further comprising a region to which a magnet may be attracted to magnetically couple the cutter to a fixture.
